(19) United States
(12) Patent Application Publication
(10) Pub. No.: US 2010/0115246 A1
(43) Pub. Date: May 6, 2010

(54) SYSTEM AND METHOD OF DATA PARTITIONING FOR PARALLEL PROCESSING OF DYNAMICALLY GENERATED APPLICATION DATA

(75) Inventors: Sundar Seshadri, Santa Clara, CA (US); Muhammad Ali Siddiqui, Reseda, CA (US); Brian Sorkin, Pasadena, CA (US); Robert Wong, Fullerton, CA (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/263,422

(22) Filed: Oct. 31, 2008

(51) Int. Cl. G06F 9/06

(52) U.S. Cl. 712/225; 712/E09.003

(57) ABSTRACT

An improved system and method of data partitioning for parallel processing of dynamically generated application data is provided. An application may send a request to partition the application data specified by a data partitioning policy and to process each of the data partitions according to processing instructions. The data partitioning policy may be flexibly defined by an application for partitioning data any number of ways, including balancing the data volume across each of the partitions or partitioning the data by data type. Asynchronous data partition processors may be instantiated to perform parallel processing of the partitioned data. The data may be partitioned according to the data partitioning policy and processed according to the processing instructions. And the results may be returned to the application.

### FIELD OF THE INVENTION

The invention relates generally to computer systems, and more particularly to an improved system and method of data partitioning for parallel processing of dynamically generated application data.

### BACKGROUND OF THE INVENTION

A major problem faced by an online advertising publisher is to process dynamically generated financial data for sale of advertisement impressions to online advertisers. Online advertisers may visit a website of an online advertising publisher to place orders for displaying advertisements on display advertisement properties which represent a collection of related web pages that have advertising space allocated for displaying advertisements. A typical order may request to display advertisements on display properties for 10 million times over a period of six months. There may be several running orders for any given advertiser at a time. In order for an online application to place an order for an advertiser, the application may check the account receivable balance and credit limit of an advertiser at the time an order is being place to verify that there is a sufficient credit limit available to place the order. For instance, the account receivable balance and any amount for running orders may be subtracted from the credit limit. To do so, an online application needs to obtain the current financial information to process the order. Such financial data may be dynamically generated as orders are placed by advertisers.

Current financial database systems may store such financial data in data tables and may keep such financial data like account receivable information and credit limits in a proprietary database table format. An online application may receive a data table with financial information for online advertisers that may be as large as a few million rows and processing each row in serial fashion by reading financial data one row at a time is inefficient for a high volume data processing system. Although functional, sequential processing of data from data tables presents a bottleneck for online applications processing orders such as online advertising orders. Furthermore, there may be multiple data types within a large data table of dynamically generated data.

What is needed is a way for an online application to efficiently process a high volume of dynamically generated data. Such a system and method should be able to process multiple data types within the dynamically generated data.

### SUMMARY OF THE INVENTION

The present invention provides a system and method of data partitioning for parallel processing of dynamically generated application data. In a data partitioning framework for parallel processing of dynamically generated application data, a data partitioning engine that partitions application data according to a data partitioning policy may be operably coupled to one or more data partition processors that may each process different partitions of the data according to processing instructions for the application data. In an implementation, an application may send a request to the data partitioning engine to partition the application data specified by a data partitioning policy and to process each of the data partitions according to processing instructions. Asynchronous data partition processors may be instantiated to perform parallel processing of the partitioned data. The data may be partitioned according to the data partitioning policy and processed according to the processing instructions. And the results may be returned to the application.

In an embodiment of a data partitioning framework for parallel processing of dynamically generated application data, a request may be received to perform parallel processing of dynamically generated data. The generated data may be partitioned according to a data partitioning policy. The data partitioning policy may be flexibly defined by an application for partitioning data any number of ways, including balancing the data volume across each of the partitions or partitioning the data by data type. Then the partitioned data may be processed according to processing instructions provided by an application. In an embodiment, the data partitions may represent different data types that may be processed in parallel by data partition processors for each data type. The processing status of the data partition may be updated after processing is finished. And the results of processing the data partitions may be returned to the application.

The present invention may be used by many applications to partition and process dynamically generated data. For instance, the present invention may be used by an online application of an advertising publisher for parallel processing of advertiser's financial information needed to complete advertisers' orders being placed for display advertising. Or the present invention may generally be used by an online application for batch processing of data. For any of these applications, the present invention may partition data for an application according to a data partitioning policy and perform parallel processing of the data partitions according to processing instructions that may be provided by an application.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components of a data partitioning framework for parallel processing of dynamically generated application data, in accordance with an aspect of the present invention;

FIG. 3 is a flowchart generally representing the steps undertaken in one embodiment of a data partitioning framework for parallel processing of dynamically generated application data, in accordance with an aspect of the present invention;

FIG. 4 is a flowchart generally representing the steps undertaken in one embodiment for partitioning application data according to a data partitioning policy, in accordance with an aspect of the present invention; and

FIG. 5 is a flowchart generally representing the steps undertaken in one embodiment for data partition processors to asynchronously perform parallel processing of the data partitions according to according to processing instructions provided by an application, in accordance with an aspect of the present invention.

### DETAILED DESCRIPTION

### Exemplary Operating Environment

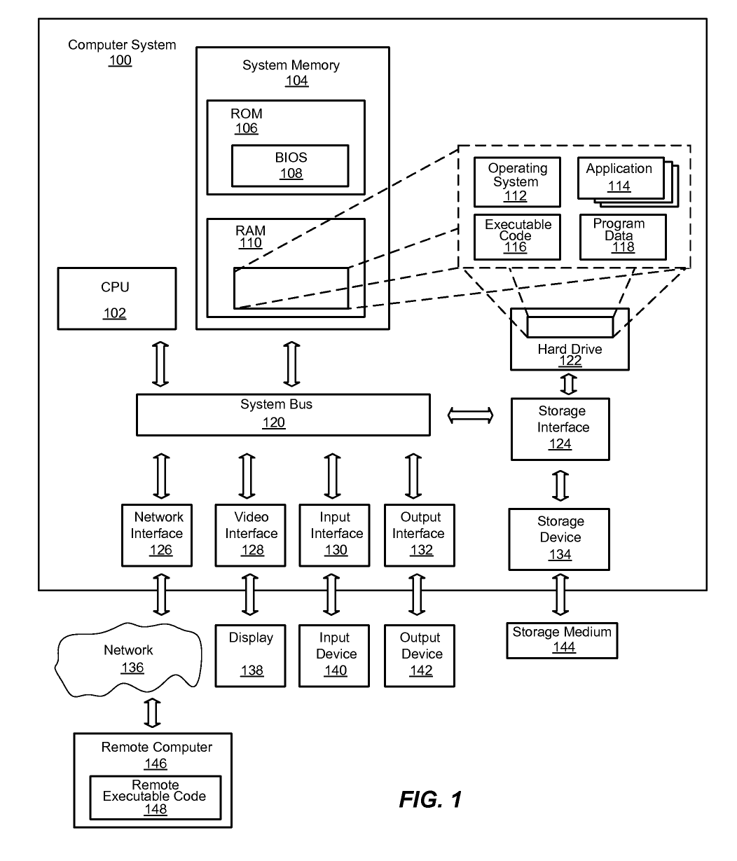

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Data Partitioning Framework for Parallel Processing of Dynamically Generated Application Data

The present invention is generally directed towards a system and method of data partitioning for parallel processing of dynamically generated application data. A data partitioning framework may be provided for parallel processing of data partitions of dynamically generated data for an application. An application may send a request to partition the application data specified by a data partitioning policy and to process each of the data partitions according to processing instructions. The data partitioning policy may be flexibly defined by an application for partitioning data any number of ways, including balancing the data volume across each of the partitions or partitioning the data by data type. Asynchronous data partition processors may be instantiated to perform parallel processing of the partitioned data. The data may be partitioned according to the data partitioning policy and processed according to the processing instructions. And the results may be returned to the application.

As will be seen, by providing a data partitioning framework for parallel processing of dynamically generated application data, the data partitions may be defined dynamically by a data partitioning policy to accommodate a high volume of dynamically generated data. The framework may be used to process any type of data in parallel, including processing multiple data types at a time. As will be understood, the various block diagrams, flow charts and scenarios described herein are only examples, and there are many other scenarios to which the present invention will apply.

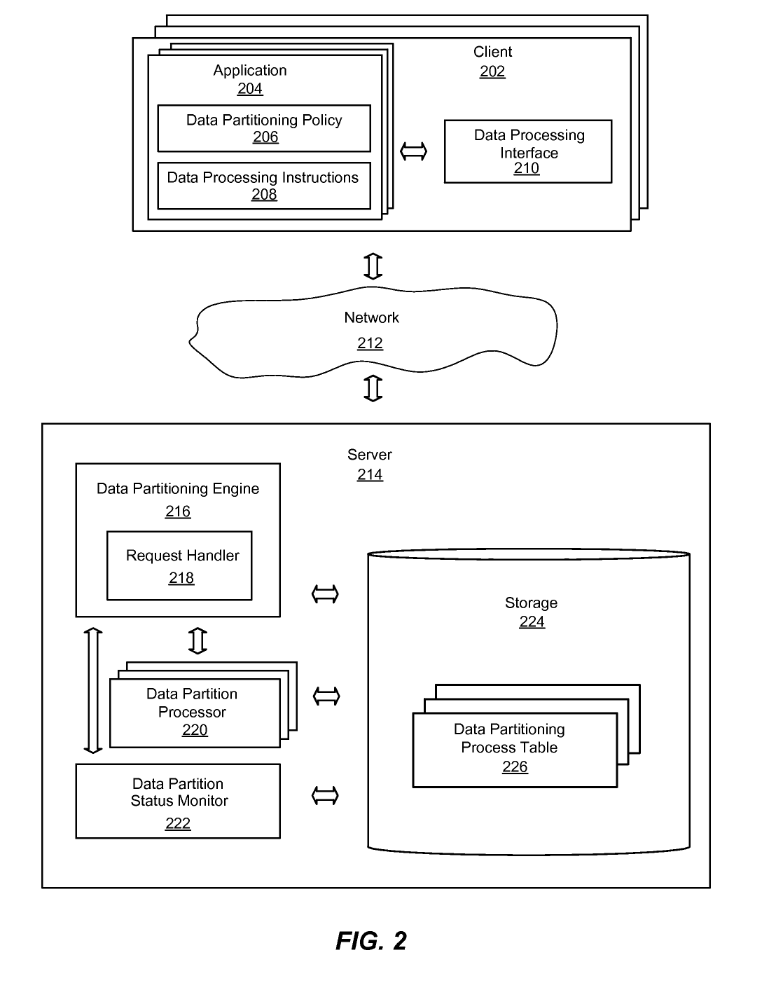

Turning to FIG. 2 of the drawings, there is shown a block diagram generally representing an exemplary architecture of system components of a data partitioning framework for parallel processing of dynamically generated application data. Those skilled in the art will appreciate that the functionality implemented within the blocks illustrated in the diagram may be implemented as separate components or the functionality of several or all of the blocks may be implemented within a single component. For example, the functionality for the data partitioning status monitor 222 may be included in the same component as the data partitioning engine 216, or the functionality of the data partitioning status monitor 222 may be implemented as a separate component from the data partitioning engine 216 as shown. Moreover, those skilled in the art will appreciate that the functionality implemented within the blocks illustrated in the diagram may be executed on a single computer or distributed across a plurality of computers for execution.

In various embodiments, a client computer 202 may be operably coupled to a server 214 by a network 212. The client computer 202 may be a computer such as computer system 100 of FIG. 1. The network 212 may be any type of network such as a local area network (LAN), a wide area network (WAN), or other type of network. One or more applications 204 may execute on the client computer 202 and may include functionality for sending a request to a server to partition application data for parallel processing. The application 204 may include a data partitioning policy 206 that provides instructions for partitioning the data and data processing instructions 208 for processing the data. The application 204 may be operably coupled to a data processing interface 210 that may include functionality for receiving a request from the application for processing data and sending the request to a server 214. In general, the application 204 and the data processing interface 210 may be any type of interpreted or executable software code such as a kernel component, an application program, a script, a linked library, an object with methods, and so forth. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The server 214 may be any type of computer system or computing device such as computer system 100 of FIG. 1. In general, the server 214 may provide services for receiving a request to partition and process data, services for partitioning and processing the data, and services for returning the results of partitioning and processing the data. The server 202 may be operably coupled to a computer storage medium such as storage 224 that may store one or more data partitioning process tables 226 used to store information about the data partitions and processing status. In an embodiment, a data partitioning process table 226 may store information such as a data partition number, a data partition type, a processing status, and so forth.

In particular, the server 214 may include a data partitioning engine 216 for partitioning data according to instructions of a data partitioning policy that may be provided by an application, one or more data partition processors 220 for processing data of a data partition according to processing instructions that may be provided by an application, and one or more data partition status monitors 222 for monitoring and updating the processing status of data partitions. The data partitioning engine 216 may include a request handler 218 for receiving a request to partition and process data and may include services for returning the results of partitioning and processing the data. Each of these components may be any type of executable software code that may execute on a computer such as computer system 100 of FIG. 1, including a kernel component, an application program, a linked library, an object with methods, or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

There are many applications that may use the data partitioning framework of the present invention to partition and process dynamically generated data. For instance, the present invention may be used by an online application of an advertising publisher for parallel processing of advertiser's financial information needed to complete advertisers' orders being placed for display advertising. Or the present invention may be generally used by an online application for batch processing of data. For any of these applications, the present invention may partition data for an application according to a data partitioning policy and perform parallel processing of the data partitions according to processing instructions that may be provided by an application.

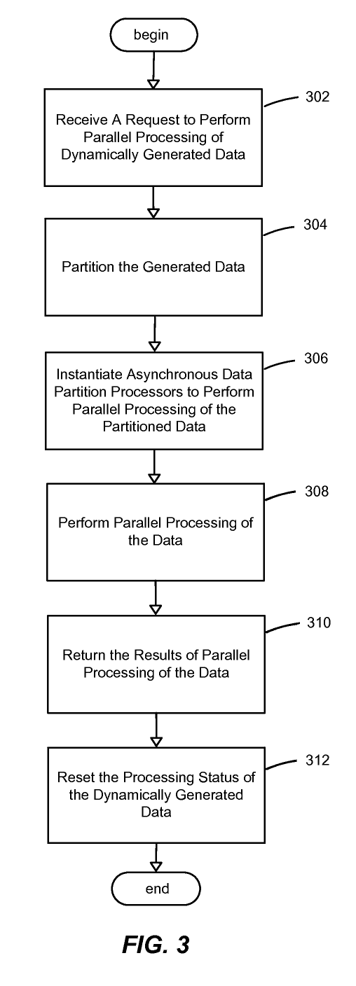

FIG. 3 presents a flowchart generally representing the steps undertaken in one embodiment of data partitioning framework for parallel processing of dynamically generated application data. At step 302, a request may be received to perform parallel processing of dynamically generated data. For example, a request may be received in an embodiment from an application that specifies a data source such as a data table, a data partition policy for partitioning the data source, and processing instructions for processing the data partitions. At step 304, the generated data may be partitioned. In an embodiment, the generated data may be partitioned according to a data partitioning policy. For example, the data partitioning policy may specify round robin, hash partitioning, or other well-known partitioning techniques. At step 306, asynchronous data partition processors may be instantiated to perform parallel processing of the partitioned data. Multiple instances of the data partition processors may run asynchronously at the same time. In an embodiment where the generated data may be partitioned by data type, there may be an instance of the data partition processor instantiated for each of the data types.

And parallel processing of the data may be performed at step 308. In an embodiment, only one instance of a data partition processor may process a data partition. In an embodiment, the partitioned data may be processed according to processing instructions provided by an application. At step 310, the results of processing the data may be returned, for instance, to an application. And at step 312, the processing status of the dynamically generated data may be updated. In an embodiment, the processing status for a partition may be updated when other partitions of the same specific type are processed completely.

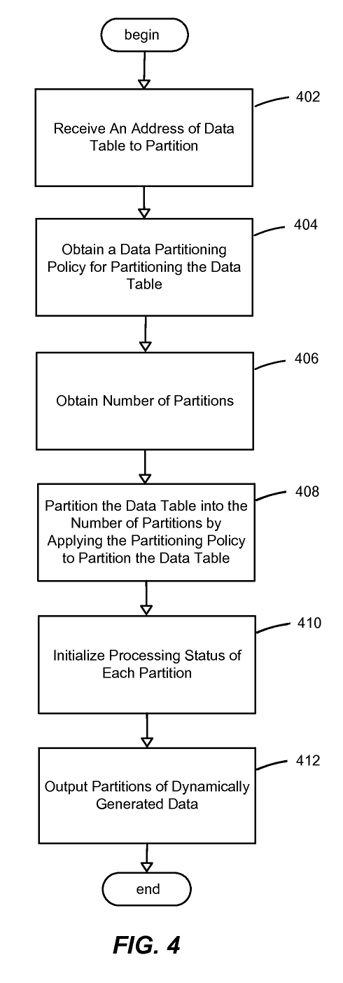

FIG. 4 presents a flowchart for generally representing the steps undertaken in one embodiment for partitioning application data according to a data partitioning policy. At step 402, an address of a data table to partition may be received in an embodiment. For example the address of an account receivable data table may be received. At step 404, a data partitioning policy may be obtained for partitioning the data table. In various embodiments, the data partitioning policy may be executable code such as a script. In other embodiments, the data partitioning policy may be a set of rules for partitioning the data table. In yet other embodiments, the data partitioning policy may specify partition information such as the number of data partitions and the location of each partition in the data table. The data partitioning policy can be as simple as allocating each data row serially to instances of data partition processors in round-robin fashion. Or the data partitioning policy may sort the data on a column and allocate the data to different buckets, including a percentage to one bucket and the rest in remaining buckets. Or the data partitioning policy may uniformly and randomly distribute the data using hashing across multiple buckets in round-robin order. Thus, the data partitioning policy may flexibly support an application for partitioning data to balance the data volume across each of the partitions. In an embodiment, the data partitioning policy may also partition the data by data type.

At step 406, the number of partitions may be obtained and at step 408, the data table may be partitioned into the number of data partitions by applying a partitioning technique specified by the data partitioning policy. In an embodiment, the data partitions may represent different data types that may be processed in parallel by data partition processors for each data type. At step 410, the processing status of each partition may be initialized. In an embodiment, the processing status for a data partition may be stored in a data partitioning process table and set to indicate that the data partition is being processed. And the data partitions may be output at step 412. For instance, the number of data partitions and the location of each data partition in the data table may be stored in a data partitioning process table.

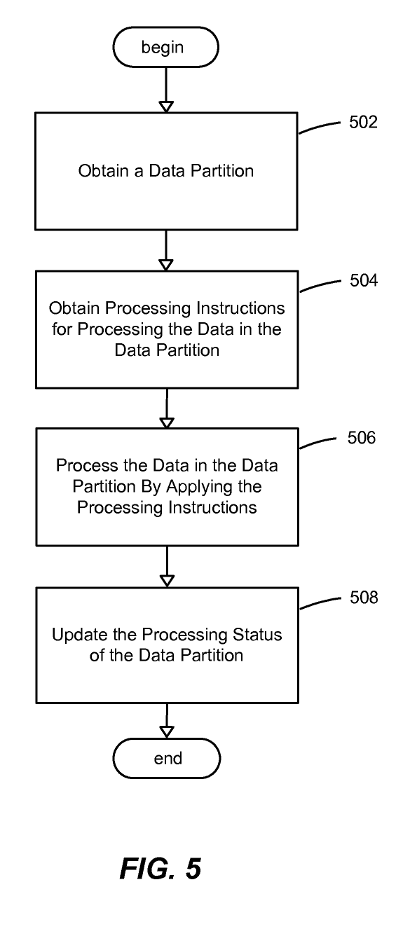

FIG. 5 presents a flowchart for generally representing the steps undertaken in one embodiment for data partition processors to asynchronously perform parallel processing of the data partitions according to processing instructions provided by an application. At step 502, a data partition may be obtained. In an embodiment, each of the data partitions may be assigned to one of several data partitioning processors. For example, each data row may be a data partition and may be assigned serially to instances of data partition processors in round-robin fashion. In this case, row 1 of a data table may be processed by a first instance of a data partition processor, row 2 of the data table may be processed by a second instance of a data partition processor, and so forth. If there are N instances of data partition processors, then row N+1 of the data table may be assigned to the first instance of the data partition processor and row N+2 may be assigned to the second instance of the data partition processor. This example illustrates a simple modulo based assignment scheme. In various embodiments, several data partition processors may be instantiated, and each may attempt to obtain a lock to any of the data partitions that has not yet had the lock claimed by another data partition processor in order to process the data partition. In this case, a data partitioning process table may store the status of the lock such as busy or free and a timestamp. In various other embodiments, a data partition processor may be assigned to a data partition based on a metric of expected processing time.

Once a data partition may be obtained, a data partitioning processor may obtain processing instructions at step 504 for processing the data partition. In an embodiment, the processing instructions may be provided by an application. In other embodiments, the processing instructions may be stored for a particular data table and application, and a data partitioning processor may lookup the processing instructions for the particular data table and application. For instance, an application may store a lookup table for an account receivable data table, a number of applications that access this data, and processing instructions for processing the data.

At step 506, the data in the data partition may be processed by the data partitioning processor by applying the processing instructions. The processing instructions may be a script, one or more rules, or an object with methods. For instance, the processing instructions may be as simple as to replicate the data set to one or more business applications. At step 508, the processing status of the data partition may be updated after processing is finished. In an embodiment, the status of a data partition stored in a data partitioning process table may be updated. Once a data partition processor has completed processing of a data partition, the data partition processor may continue to process data partitions according to the data processing instructions until there are no remaining unprocessed data partitions.

Thus the present invention may provide a partitioning framework that may process a high volume of dynamically generated data in parallel subsets. Importantly, the data partitions may be defined dynamically by a data partitioning policy to accommodate a high volume of dynamically generated data. The framework may be used to process any type of data in parallel, including processing multiple data types at a time. Any number of data partition processors may be instantiated for processing each of the data partitions asynchronously. And a data partitioning policy may be flexibly defined by an application for partitioning data any number of ways, including balancing the data volume across each of the partitions or partitioning the data by data type.

As can be seen from the foregoing detailed description, the present invention provides an improved system and method of data partitioning for parallel processing of dynamically generated application data. A data partitioning framework may be implemented for an application to specify a data partition policy for partitioning a data source and processing instructions for processing the data partitions. The application may send a request to perform parallel processing of dynamically generated data. Asynchronous data partition processors may be instantiated to perform parallel processing of the partitioned data. The data may be partitioned according to the data partitioning policy and processed according to the processing instructions. And the results may be returned to the application. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for parallel processing of application data, comprising:
a data partitioning engine that partitions application data according to a data partitioning policy and processes each of a plurality of data partitions according to processing instructions for the application data;
a data partition processor operably coupled to the data partitioning engine that processes at least one of the plurality of data partitions according to the processing instructions for the application data; and
a storage operably coupled to the data partitioning engine that stores a data partitioning process table with information including an identification of each of the plurality of data partitions and processing status of each of the plurality of data partitions.

2. The system of claim 1 further comprising a data partition status monitor operable coupled to the data partitioning engine that monitors and updates the processing status of at least one of the plurality of data partitions.

3. The system of claim 1 further comprising an application operably coupled to the data partitioning engine that sends a request to partition the application data and process each of the plurality of data partitions according to the processing instructions for the application data.

4. The system of claim 3 further comprising a data processing interface operably coupled the application that receives the request to partition the application data and process each of the plurality of data partitions according to the processing instructions for the application data and sends the request to the data partitioning engine.

5. The system of claim 3 further comprising the data partitioning policy operably coupled to the application that specifies instructions for partitioning the application data.

6. The system of claim 3 further comprising the processing instructions operably coupled to the application that specifies data processing instructions for processing the application data.

7. A computer-readable medium having computer-executable components comprising the system of claim 1.

8. A computer-implemented method for parallel processing of application data, comprising:
receiving a request to perform parallel processing of application data;
partitioning the application data into a plurality of data partitions specified by a data partitioning policy;
processing the plurality of data partitions asynchronously by a plurality of data processors according to processing instructions for the application data; and
outputting results from processing the plurality of data partitions according to the processing instructions for the application data.

9. The method of claim 8 further comprising instantiating the plurality of data processors to asynchronously process the plurality of data partitions according to processing instructions for the application data.

10. The method of claim 8 further comprising instantiating a plurality of data partition monitors that asynchronously monitor a processing status of each of the plurality of data partitions.

11. The method of claim 8 further comprising initializing a processing status of each of the plurality of data partitions.

12. The method of claim 8 further comprising monitoring a processing status of each of the plurality of data partitions.

13. The method of claim 8 further comprising updating a processing status of each of the plurality of data partitions.

14. The method of claim 8 wherein receiving the request to perform parallel processing of application data comprises receiving an address of a data table.

15. The method of claim 8 further comprising obtaining the data partitioning policy from the application for partitioning the application data into the plurality of data partitions specified by the data partitioning policy.

16. The method of claim 15 further comprising obtaining a number of partitions from the data partitioning policy for partitioning the application data into the plurality of data partitions.

17. The method of claim 8 further comprising obtaining the processing instructions for the application data from the application for processing the plurality of data partitions asynchronously by a plurality of data processors.

18. A computer-readable medium having computer-executable instructions for performing the method of claim 8.

19. A computer system for parallel processing of application data, comprising:
means for receiving instructions to partition application data into a plurality of data partitions;
means for receiving instructions to process each of the plurality of data partitions;
means for partitioning the application data into the plurality of data partitions;
means for processing each of the plurality of data partitions; and
means for outputting the results of processing each of the plurality of data partitions.

20. The computer system of claim 19 further comprising:
means for sending the instructions to partition the application data into the plurality of data partitions;
means for sending the instructions to process each of the plurality of data partitions.
